(19) United States
(12) Patent Application Publication
(10) Pub. No.: US 2021/0392640 A1
(43) Pub. Date: Dec. 16, 2021

(54) METHOD AND DEVICE FOR SHARED FRAME CONFIGURATION OF MULTIPLE (SUB) SYSTEMS

(71) Applicant: MediaTek Singapore Pte. Ltd., Singapore (SG)

(72) Inventors: Tao CHEN, Beijing (CN); Min LEI, Beijing (CN)

(21) Appl. No.: 17/345,114

(22) Filed: Jun. 11, 2021

(30) Foreign Application Priority Data
Jun. 12, 2020 (CN) 202010537313.6
Jul. 29, 2020 (CN) 202010746681.1
Sep. 10, 2020 (CN) 202010948521.5
Jun. 2, 2021 (CN) 202110612572.5

(51) Int. Cl. H04W 72/04; H04J 3/16; H04W 72/10

(52) U.S. Cl. CPC H04W 72/0446; H04W 72/10; H04J 3/1694

(57) ABSTRACT

A method for shared frame configuration of multiple (sub)systems is provided. The method is executed by a first device of a first (sub)system and includes: determining whether the first (sub)system is a highest-priority system; and determining the allocation of resources of time symbols in a shared frame in the multiple (sub) systems when the first (sub)system is a highest-priority system.

### CROSS REFERENCE TO RELATED APPLICATIONS

This application claims priority of China Patent Application No. 202010537313.6, filed on Jun. 12, 2020, China Patent Application No. 202010746681.1, filed on Jul. 29, 2020, China Patent Application No 202010948521.5, filed on Sep. 10, 2020, and China Patent Application No 202110612572.5, filed on Jun. 5, 2021, the entirety of which are incorporated by reference herein.

### BACKGROUND

### Technical Field

The present disclosure is related in general to the field of wireless communication systems, and in particular it is related to a method and a device for shared frame configuration of multiple (sub)systems.

### Description of the Related Art

With the continuous development of in-vehicle business, how to design a wireless communication system for in-vehicle wireless short-range communication is obviously a problem that needs to be solved urgently. In addition, the coexistence of multiple systems and subsystems needs to be considered.

Therefore, there is a need for a method and device for shared frame configuration of multiple (sub)systems to solve the problem described above.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and device for shared frame configuration of multiple (sub)systems to overcome the above disadvantages.

In an exemplary embodiment, a method for shared frame configuration of multiple (sub)systems, wherein the method is used in a first device of a first (sub)system and comprises: determining whether the first (sub)system is a highest-priority system; and determining the allocation of resources of time symbols in a shared frame in the multiple (sub)system when the first (sub)system is a highest-priority system.

In some embodiments, the method further comprises: broadcasting configuration information, wherein the configuration information indicates the time symbols used for the first (sub)system in the shared frame.

In some embodiments, the method further comprises: receiving a signaling request from a second (sub)system, wherein the signaling request is used to request the first (sub)system to reserve at least one time symbol in the shared frame for the second (sub)system to transmit information; and reconfiguring the time symbols used in the first (sub)system in the shared frame according to the signaling request.

In some embodiments, when a plurality of systems time-division multiplex the shared frame, the first (sub)system configures the resources of a discrete time symbol and avoids the allocation of dedicated GP resources; and wherein when no system uses the shared frame except for the first (sub)system, the first (sub)system configures the shared frame to have the dedicated GP resources.

In some embodiments, the first device determines whether the first (sub)system is a highest-priority system based on a synchronization sequence number of the first (sub)system.

In some embodiments, the shared frame is composed of the time symbols, a first interval time (GT1) and a second interval time (GT2) in sequence.

In some embodiments, the first interval time is an invalid symbol for configuring dedicated GP resources.

In some embodiments, when the first (sub)system is a second highest-priority system, the shared frame is composed of a first interval time (GT1), the time symbols, and a second interval time (GT2) in sequence.

In some embodiments, the information is control information, feedback information, synchronization signals or broadcast information.

In some embodiments, the at least one the time symbol is a time symbol before or after a switching point of the shared frame.

In an exemplary embodiment, a device for shared frame configuration of multiple (sub)systems comprises: one or more processors; and one or more computer storage media for storing one or more computer-readable instructions, wherein the processor is configured to drive the computer storage media to execute the following tasks: determining whether the first (sub)system is a highest-priority system; and determining the allocation of resources of time symbols in a shared frame in the multiple (sub) system when the first (sub)system is a highest-priority system.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 illustrates a schematic diagram of a wireless communication system according to an embodiment of the present disclosure.

FIG. 2 is a structural diagram of a scheduling unit according to an embodiment of the present disclosure.

FIG. 3 is a flowchart of a method for shared frame configuration of a multiple (sub)system according to the first embodiment of the present disclosure.

FIG. 4 is a schematic diagram showing the structure of a shared frame of multiple (sub)systems according to an embodiment of the present disclosure.

FIG. 5 is a schematic diagram illustrating another structure of a shared frame used in multiple (sub)systems according to an embodiment of the present disclosure.

FIG. 6 is a flowchart of a method for shared frame configuration of a multiple (sub)system according to the first embodiment of the present disclosure.

FIG. 7 is a schematic diagram illustrating the structure of a shared frame of a multiple (sub)system according to an embodiment of the present disclosure.

FIG. 8 illustrates an exemplary terminal node according to an embodiment of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The present disclosure relates to a wireless communication system, which can be used for in-vehicle wireless short-range communication, specific related system design and other key technologies. To meet the high reliability and low latency requirements of certain services (such as in-vehicle active noise reduction services), control and system information need to be specially designed.

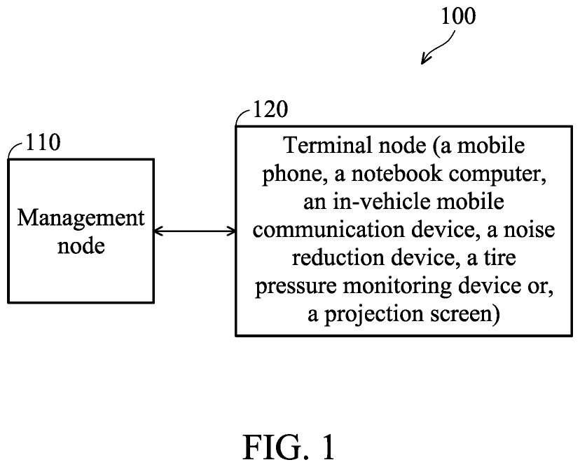

FIG. 1 illustrates a schematic diagram of a wireless communication system 100 according to an embodiment of the present disclosure. The system 100 may adopt 3/4/5G or other (wireless short-range) communication technologies developed by the 3rd Generation Partnership Project (3GPP). The wireless communication system 100 may comprise a management node 110 and a terminal node 120. The management node 110 has the functions of transmitting synchronization signals, broadcast information, high-level control plane messages, physical layer control signaling, and demodulation reference signals, and schedules the terminal nodes to perform data transmission and transmit feedback information. The management node 110 may also be a device such as a base station. Although only one management node 110 is shown in FIG. 1, there may be multiple management nodes 110 in the deployment to control different (sub)systems. The management nodes 110 can communicate and coordinate with each other.

The terminal node 120 may be a mobile phone, a notebook computer, an in-vehicle mobile communication device, a noise reduction device, a tire pressure monitoring device, a projection screen, and other similar devices. Similarly, the terminal node 120 may use one or more antenna arrays to generate directional Tx or Rx beams to transmit or receive wireless signals. Although only one terminal node 120 is shown in FIG. 1, the management node 110 can serve and control multiple terminal nodes 120 at the same time.

In operation, the terminal node 120 can detect synchronization signals, broadcast information, control information, data information, system information, etc. from the management node 110. The control information is used to carry information related to data scheduling or is used independently for the control of the physical process. At the same time, the terminal node 120 can transmit corresponding feedback information to the management node 110, such as hybrid automatic repeat request (HARQ) feedback information, SRS signals, channel condition feedback information, and so on. The terminal node 120 may receive data carried in the physical downlink shared channel from the management node 110 and transmit data to the management node 110 in the physical uplink shared channel. Regarding whether each symbol is used for transmission by the management node 110 or by the terminal node 120, the symbol in the frame as C (for transmission by the management node 110) or T (for transmission by the terminal node 120) in the transceiver symbol configuration) may be marked in the broadcast signaling.

There are a variety of embodiments in the present disclosure. Three embodiments are used below to describe the three main embodiments of the present disclosure. The first embodiment is an implementation manner designed for the frame structure of an in-vehicle short-range wireless communication system. The second embodiment and the third embodiment are implementations of coexistence of time-division multiplexing resources in multiple (sub)systems, wherein the third embodiment is a frame structure used by the terminal node working in different (sub)systems. The first embodiment is described first.

It should be noted that, as used in the disclosure, a system or subsystem may also be called a “domain”.

### First Embodiment

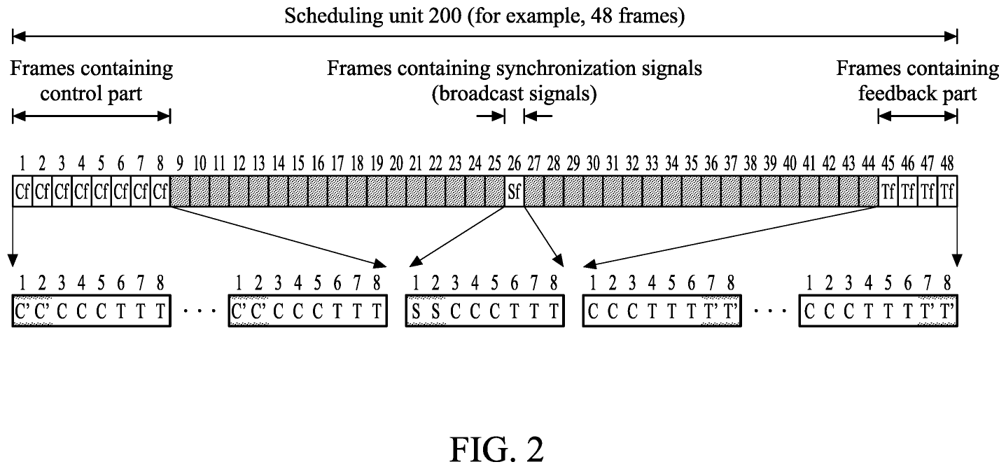

FIG. 2 is a structural diagram of a scheduling unit 200 according to an embodiment of the present disclosure, which shows the placement positions of exemplary control information, feedback information, synchronization signals, etc. of the present disclosure.

A method for dividing resources of frame structure in a wireless communication system is provided in the present disclosure. The method may comprise selecting several symbol combinations in several frames to transmit control information or feedback information together. First, a scheduling unit 200 may be composed of multiple frames, such as 48 frames as shown in FIG. 2.

For control information, several frames (such as 8 frames) at the beginning of the 48-frame configuration are frames Cf containing control information, wherein several control symbols C′ are selected for the transmission of control information in each frame. Therefore, as shown in FIG. 2, in the 48 frames of a scheduling unit, each of the first 8 frames can be used to select two symbols (16 symbols in total) for the transmission of control information. In this way, the terminal node may first receive the control information, and decide whether to continue to receive the remaining frames in the scheduling unit according to the decoded content of the control information, thereby saving power and avoiding unnecessary power consumption. Signaling or stipulating that the calculation of the starting point of the scheduling unit 200 comprises the position and number of control part frames, and the position and number of symbols used for control in each frame. In addition, the SLIV method (indicating the number of starting frames and the number of consecutive frames) may be simplified to indicate the number and positions of the frames containing the control part. Similarly, the SLIV method (indicating the number of starting symbols and the number of consecutive symbols) may be simplified to indicate the positions and number of symbols used for control in each frame. Furthermore, it can be simplified to signal or stipulate the number of consecutive frames containing the control part starting from the first frame of the scheduling unit 200. Similarly, it can be simplified to signal or stipulate the number of consecutive control symbols in each frame starting from the first symbol.

For feedback information, the method is used like that of control information, but the starting frame may be calculated from the last frame of the scheduling unit 200 forward. Several frames (such as 8 frames) at the end of the 48-frame configuration are frames Tf containing control information, and several control symbols T′ are selected in each frame for the transmission of control information. Therefore, as shown in FIG. 2, in the 48 frames of the scheduling unit 200, two symbols (8 symbols in total) can be selected from each of the last 4 frames for the transmission of control information. In this way, the terminal node may transmit feedback information based on the received control data, which provides the possibility for rapid feedback. Signaling or stipulating that the calculation of the end point of the scheduling unit 200 comprises the position and number of feedback part frames, and the position and number of symbols used for feedback in each frame. In addition, the SLIV method (indicating the number of starting frames and the number of consecutive frames) may be simplified to indicate the number and positions of the frames containing the feedback part. Similarly, the SLIV method (indicating the number of starting symbols and the number of consecutive symbols) may be simplified to indicate the positions and number of symbols used for feedback in each frame. Furthermore, it can be simplified to signal or stipulate the number of consecutive frames containing the feedback part starting from the last frame of the scheduling unit 200 in reverse. Similarly, it can be simplified to signal or stipulate the number of consecutive control symbols in each frame starting from the last symbol in reverse.

Based on this design, the transmission of control information may be located at the front end of the scheduling unit, and the feedback information may be located at the back end of the scheduling unit. It is helpful to save energy and reduce latency.

In addition, for the control information, the frequency resources (the starting point and/or bandwidth of the frequency domain) may be configured, so that other remaining frequency resources may still be used for data transmission. In addition, the feedback information may be configured periodically, for example, one scheduling unit as a unit, and a set of feedback resources are configured for every N scheduling units. Or a group of resources are configured for every N milliseconds. This avoids frequent feedback and reduces system overhead. For the feedback information, the used frequency resources (the starting point and/or bandwidth of the frequency domain) may be configured, so that other remaining frequency resources may still be used for data transmission.

In addition, the calculation of the control part of the frame or the feedback part of the frame may be physically continuous or logically continuous (that is, only valid frames and/or valid symbols are considered).

For the synchronization information, the synchronization information is transmitted periodically, and the period may be configured and indicated. The initial access of the terminal node may adopt the default period (for example, 20 ms) to receive. The synchronization signal may be fixedly placed near the intermediate frame of the scheduling unit, so as to avoid conflicts with the control part of the frame or the feedback part of the frame. Once there is a (symbol) conflict, for the control or feedback part of the frame, the synchronization signal frame (and/or broadcast message frame/symbol) may be skipped to postpone the calculation of the number of frames (i.e., non-continuous) or the synchronization signal frame (and/or broadcast message frame/symbol) may be skipped but not to postpone the calculation of the number of frames.

For the broadcast information, on-demand transmission may be used. The terminal node may transmit a request message, and the management node transmits a corresponding system message to the terminal node according to the received request message. The management node may configure time-frequency resources and code resources to correspond to one or more different system messages. When the terminal node needs a certain system message, the terminal node may trigger the management node to correspondingly transmit the corresponding system message by using the corresponding code resource to transmit the information in the corresponding time-frequency resource. The resource configuration may be public or specific to the terminal node. For example, the terminal node may be configured with the corresponding time-frequency resources and offset or code resources by transmitting a corresponding physical signal (such as a sounding reference signal (SRS) or a feedback signal like PUCCH) to request a corresponding system message. When the resource configuration is public, the management node may broadcast the resource configuration after receiving the corresponding physical signal, and scramble the CRC by broadcasting ID. When the resource configuration is specific to the terminal node, the management node may unicast the resource configuration after receiving the corresponding physical signal, scramble the CRC by using the ID of the terminal node, and use self-adjustment mechanism of the corresponding link to improve the transmission performance. In addition, the terminal node may also request system messages by transmitting a data channel, wherein the required system information is carried in the data channel. When there is data transmission, the requested system message indication may also be carried in the MAC header.

In addition, for different device types, the adopted methods can be different. For example, for in-vehicle fixed devices, the device information and ID have been stored in the management node, and device-specific configurations can be adopted. For mobile devices (such as mobile phones), configurations of public settings can be adopted. The device type can be reported as the device capability when establishing a connection or registering for the first time, and the management node may perform different settings and scheduling according to the device type.

At the same time, for the switching capabilities of different devices, one symbol before or after the switching point of each frame can be additionally used for switching. After the additional switching symbol is reported by the terminal node to the management node, the management node reserves the corresponding symbols through scheduling. In addition, the synchronization signal may be periodically placed at a specific position in certain frames and provide certain timing information.

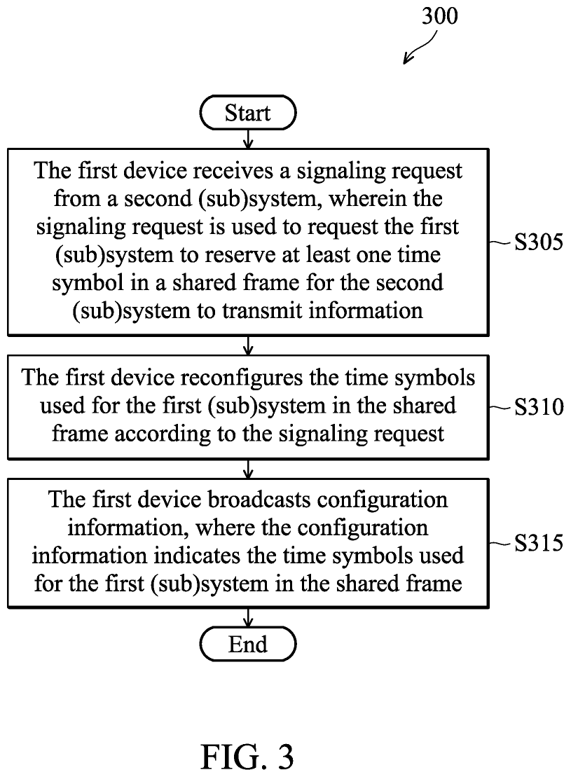

FIG. 3 is a flowchart of a method 300 for shared frame configuration of multiple (sub)systems according to the first embodiment of the present disclosure. The method 300 is used in a first device of a first (sub)system, wherein the first (sub)system is a highest-priority system.

In step S305, the first device receives a signaling request from a second (sub)system, wherein the signaling request is used to request the first (sub)system to reserve at least one time symbol in a shared frame for the second (sub)system to transmit information. In an embodiment, the information is control information, feedback information, a synchronization signal or broadcast information. In another embodiment, the at least one time symbol is a time symbol before or after the switching point of the shared frame.

Next, in step S310, the first device reconfigures the time symbols used for the first (sub)system in the shared frame according to the signaling request. In other words, the first device reserves at least one time symbol requested by the second (sub)system for the second (sub)system to transmit information.

Finally, in step S315, the first device broadcasts configuration information, where the configuration information indicates the time symbols used for the first (sub)system in the shared frame.

### Second Embodiment

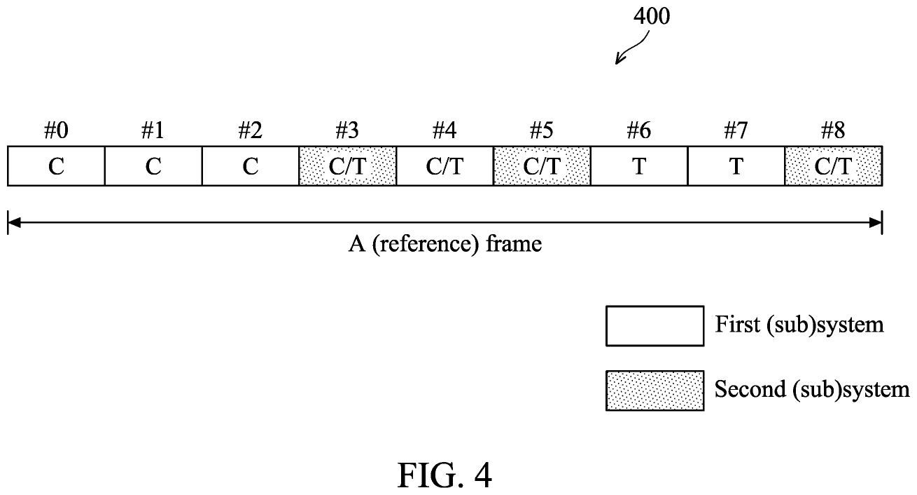

FIG. 4 is a schematic diagram showing the structure of a shared frame 400 of multiple (sub)systems according to an embodiment of the present disclosure. As shown in FIG. 4, two (sub)systems share C link (or downlink) symbols and T link (or uplink) symbols in one frame 400.

As shown in FIG. 4, in a (reference) frame 400 containing 9 symbols, the first (sub)system uses the symbol #0/1/2/4/6/7 in the frame 400, and the second (sub)system uses the remaining symbols (#3/5/8) in the frame 400. These two (sub)systems implement symbol-level time division multiplexing by using different symbols in the frame 400. The multiple (sub)systems may have different subcarrier spacings and cyclic prefix lengths. Therefore, the structure of a reference frame 400 can be defined based on a reference subcarrier spacing and cyclic prefix. When the sub-carrier spacing and cyclic prefix length used by each (sub)system are the same, the (sub)systems may share the sub-carrier spacing and cyclic prefix length directly based on the frame structure, without defining a reference frame structure. As shown in FIG. 4, some symbols used by the first (sub)system in the (reference) frame 400 structure may be distributed non-continuously in time. Therefore, the first (sub)system may use the position of the symbol #3 of the second (sub)system for flexible reception or transmission, so that the symbol #4 may be flexibly set as a C (downlink) or T (uplink) symbol. Similarly, the second (sub)system may use the positions of the symbols #2, #4, and #6/7 of the first (sub)system to perform reception or transmission, so that the symbols #3, #5 and #8 may be flexibly set to C (downlink) or T (uplink) symbol. In this way, for the operation of the entire shared system, there is no need to reserve special GP time and symbols, which improves the efficiency of time resource utilization and provides the possibility of flexible reception and transmission configuration of the (sub)systems at the symbol level in the same frame.

In addition, different (sub)systems may define their own scheduling frames, and the scheduling frame is composed of a plurality of (reference) frames and symbols of the (sub)systems in the frames. The scheduling frame may be composed of consecutive N (reference) frames or consecutive N valid (reference) frames. When no symbols are defined in a frame for the (sub)system to use, the frame may be defined as an invalid (reference) frame. The length of the scheduling frame may be given in system signaling or scheduling signaling. The terminal node may obtain the number of effective time resources based on the length of the scheduled frame (that is, the number of frames) and the valid available symbols in the frame (some positions of the system resource overhead symbols may be excluded). In addition, each (sub)system may also configure its own public superframe structure for placing some system messages (for example, synchronization signals, broadcast signals, and so on). Different from the scheduling frame, the superframe has a fixed length and is mainly used to define the placement positions of system public messages.

In addition, different (sub)systems may have their own synchronization signals and/or sequences to distinguish different (sub)systems. For example, the synchronization sequence number {0, . . . , 21} is used by the first (sub)system, and the synchronization sequence number {22, . . . , 36} is used by the second (sub)system or other subsystems. The terminal node may identify the system category and/or the priority of the system based on the synchronization sequence number. For example, the first (sub)system is a highest-priority system, and the second (sub)system is a (second highest) priority system.

In an embodiment, the signal sequence d_{FTS}(n) can be expressed by the following formula:

$${d}_{F T S} ( n ) = \{ \begin{matrix}exp ( - j \frac{π u n ( n + 1 )}{41} ) , & n = 0 , 1 , . . . , 18 \\ 0 , & n = 19 \\ exp ( - j \frac{π u n ( n + 1 )}{41} ) , & n = 20 , 21 , . . . , 38\end{matrix}$$

wherein, the highest-priority system u=1, and the (second highest) priority system u=40.

The terminal node or management node of the second (sub)system may search for the first (sub)system periodically or during initial establishment and determine whether the first (sub)system exists. When the first (sub)system exists, the second (sub)system may communicate with the first (sub)system and transmit a signaling request to reserve certain symbol positions in the frame for transmission by the second (sub)system. After the management device of the first (sub)system receives the signaling request, the management device may confirm the signaling request and inform the corresponding positions of the symbols. At the same time, the management device of the first (sub)system may update the system broadcast message indicating the positions of the symbols that can be used in the first (sub)system in the new frame structure. Similarly, when the second (sub)system no longer exists or the number of terminal nodes is less, the management node of the second (sub)system may inform the management node of the first (sub)system to request to take back all or part of the resources occupied by the second (sub)system. The management node of the first (sub)system may readjust the resource configuration after receiving signaling request, recover the resources occupied by the second (sub)system, reuse the recovered resources in the first (sub)system, and update the available resources (available symbols and positions in the frame) of the first (sub)system through signaling.

In addition, the first (sub)system may also determine the change of the frame structure according to the presence or absence of other (sub)systems. For example, when there is a second (sub)system or other subsystems, the 9-symbol (reference) frame structure is used; when there is no second (sub)system or other subsystems, (that is, when only the first system exists), a new (reference) frame structure is adopted, wherein the new (reference) frame structure may contain specific GP positions or symbols (for example, only 8 symbols plus two GP positions) for reception or transmission of the first (sub)system. In other words, when multiple (sub)systems share the frame structure at the symbol level, GP symbols may not be required. Therefore, each (sub)system or at least the first (sub)system may specify the used (reference) frame structure in the broadcast message, which may comprise one or more of the following parameters: the total number of symbols in the (reference) frame, whether the (reference) frame contains dedicated GP, available symbols in each frame. The (reference) frame structure may be defined in the table by tabulation and be indicated by the index given by the signaling. In addition, the effective time of the release, establishment, and update of the (sub)system may be determined based on a certain absolute time of a timer or signaling broadcast to ensure that there will be no ambiguity.

When different (sub)systems have priorities, for example, when the first (sub)system has the highest priority, the terminal nodes or the management nodes of the non-first (sub)system should preferentially search for the first (sub)system. Therefore, the first (sub)system may have a different synchronization sequence with the second (sub)system or other (sub)systems to distinguish priority. The specific search order or priority order may be based on pre-configuration or network configuration.

In addition, when the (sub)system transmits a broadcast message (similar to the Master Information Block (MIB)), the broadcast message may be divided into multiple segments and transmitted, and each segment is scheduled to be transmitted in different superframes. Therefore, each segment needs to be given a segment number, and the terminal node may infer the specific superframe number based on the segment number, and thereby allowing (sub)system timing. It is assumed that there are 4 segments in total and 2-bit information is required, these 2-bit information may be carried in the broadcast message and placed in the most reliable position in the corresponding Polar encoding to achieve early and accurate decoding of the segment number. The early decoding of the segment number may be further used for combined decoding of multiple segments of broadcast information. In addition, the 2-bit information of the segment number may also be scrambled and carried in the CRC of the broadcast message, and the terminal node may merge the multiple segments through blind decoding.

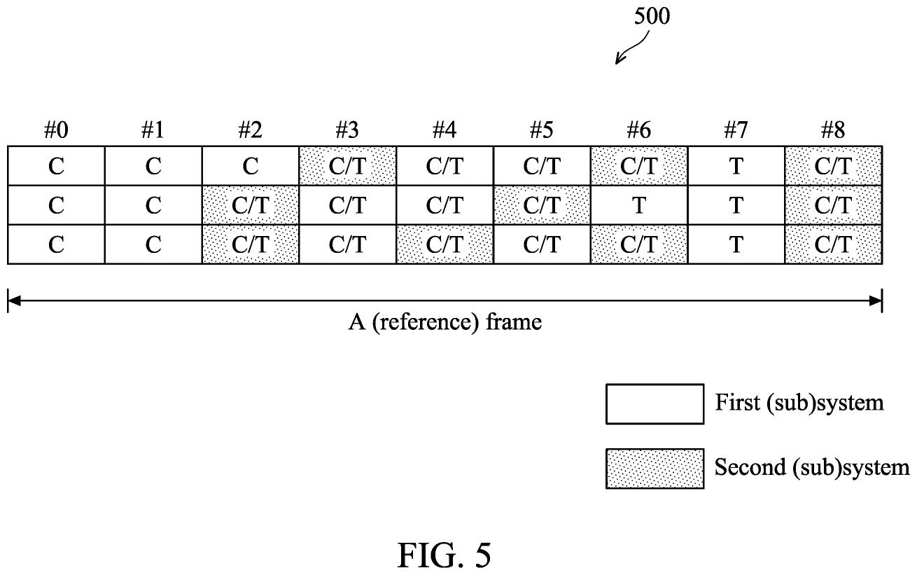

FIG. 5 is a schematic diagram illustrating another structure of a shared frame 500 used in multiple (sub)systems according to an embodiment of the present disclosure. When the first symbol #0 of the frame is used for the transmission of the first (sub)system, the last symbol #8 of the frame is applied to the second (sub)system or other (sub)systems to at least ensure that the first (sub)system may use symbols of other (sub)systems (the last symbol of each frame of the first subsystem is reserved for other (sub)systems) or reserved symbols for reception or transmission between the received symbol at the end of each frame and the first transmitted symbol of the next frame. For the first (sub)system, the symbols used in other (sub)systems may be set as reserved symbols, and the first (sub)system may notify the terminal node that the reserved symbols are unavailable through (broadcast) signaling. Similarly, for other (sub)systems, symbols that do not belong to other (sub)systems may also be marked as the reserved symbols through broadcast signaling to inform the terminal nodes that the reserved symbols are not available. In this way, each (sub)system uses only the resources available in each frame.

In addition, certain symbols may be shared by multiple (sub)systems and temporarily marked as available or unavailable by dynamic signaling. When the frame structure is given in the signaling, it is not necessary to give the frame structure of other (sub)systems in the signaling. Only the symbol positions required by the system may be given in the signaling, and other positions are marked as reserved or unavailable. In addition, some positions of the symbols may be marked as shared to indicate that the symbol is unavailable by default and is only available when the signaling clearly indicates that the position is available, such as during data scheduling. Certain symbols may be indicated whether the symbols can be used for (data) transmission by the semi-static, static, or dynamic signal. In principle, the control channel and system overhead are not mapped on this shared symbol.

The management node of the first (sub)system or the central node that controls multiple (sub)systems may provide the number of symbols and position allocation of other (sub)systems or between systems, and then each (sub)system determines the reception and transmission of each allocated symbol or uplink and downlink allocation of each allocated symbol, and informs terminal nodes through signaling broadcast.

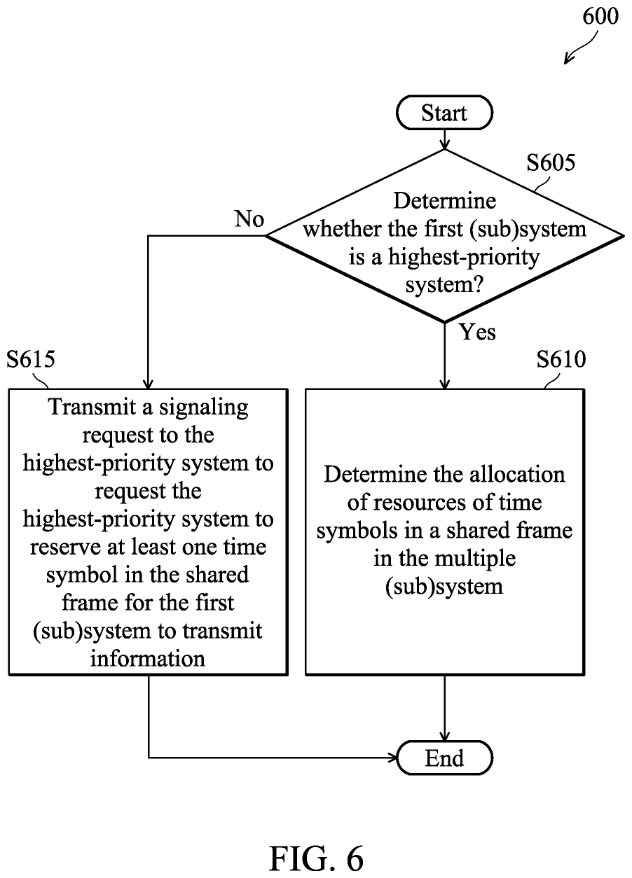

FIG. 6 is a flowchart of a method 600 for shared frame configuration of multiple (sub)systems according to the first embodiment of the present disclosure. The method 600 is used in a first device of a first (sub)system.

In step S605, the first device determines whether the first (sub)system is a highest-priority system, wherein the first device determines whether the first (sub)system is a highest-priority system based on the synchronization sequence number of the first (sub)system.

When the first (sub)system is a highest-priority system (“Yes” in step S605), in step S610, the first device determines the allocation of resources of time symbols in a shared frame in the multiple (sub)system.

When the first (sub)system is not the highest-priority system (“No” in step S605), in step S615, the first device may transmit a signaling request to the highest-priority system to request the highest-priority system to reserve at least one time symbol in the shared frame for the first (sub)system to transmit information.

### Third Embodiment

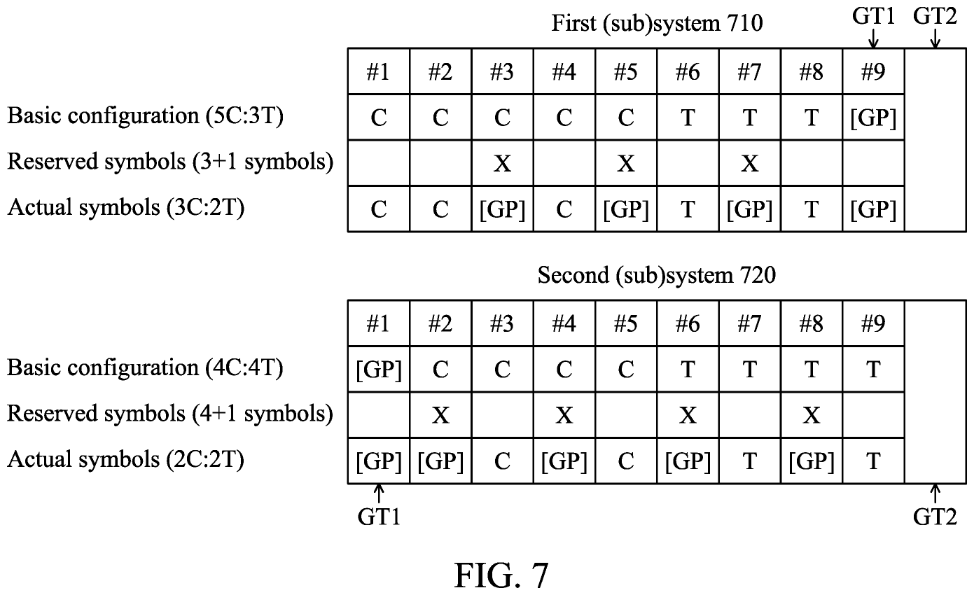

FIG. 7 is a schematic diagram illustrating the structure of a shared frame of a multiple (sub)system according to an embodiment of the present disclosure. As shown in FIG. 7, two (sub)systems share C link (or downlink) symbols and T link (or uplink) symbols in one frame.

It is assumed that the length of a radio frame in a wireless short-range communication system is Tf=640×Ts, which is about 20.833 us, wherein Ts=1/30.72 Mhz=0.0326 us, and CP-OFDM symbols are used for transmission. The CP-OFDM symbol comprises a cyclic prefix part and a valid data part in the time domain. The length of the effective data part is 64 Ts, which is about 2.0833 us. The length of the cyclic prefix is divided into two cases, namely the regular cyclic prefix and the extended cyclic prefix. The length of the regular cyclic prefix is 5 Ts, which is about 0.1628 us, and each radio frame contains 8 CP-OFDM symbols. The length of the extended cyclic prefix is 14 Ts, which is about 0.4557 us, and each radio frame contains 7 CP-OFDM symbols.

In the in-vehicle wireless short-range communication system, each radio frame is firstly transmitted on the C link, and then transmitted on the T link. In each radio frame, the switching interval after the C link transmission ends is the first switching interval, and the switching interval after the T link transmission ends is the second switching interval. In the case of a regular cyclic prefix, the duration of each switching interval is 44 Ts, which is about 1.4322 us. In the case of an extended cyclic prefix, the duration of each switching interval is 47 Ts, which is about 1.5299 us.

Therefore, when multiple (sub)systems share transmission, additional support for a new frame structure can be considered. The new frame structure no longer specifically sets GP symbols, but the symbols in the frame are interlaced and used in the new frame structure by supporting multiple (sub)systems. The symbols of multiple (sub)systems are mutually GPs to realize the switching of reception and transmission, so as to make full use of resources and avoid the GP overhead dedicated to switching of reception and transmission.

In the new frame structure, the length of the valid data part is still 64 Ts, which is about 2.0833 us. The length of the cyclic prefix in the new frame structure is still divided into two cases, namely the regular cyclic prefix and the extended cyclic prefix. For the regular cyclic prefix frame structure (as shown in TABLE 1), the length of the regular cyclic prefix of the first symbol (or the last symbol) is 8 Ts, which is about 0.2604 us, and the length of the regular cyclic prefix of other symbols is 7 Ts, which is about 0.2279 us. The frame structure of the regular cyclic prefix comprises 9 CP-OFDM symbols. For the frame structure of the extended cyclic prefix (as shown in TABLE 2), the length of the extended cyclic prefix is 16 Ts, which is about 0.5208 us. Each radio frame comprises 8 CP-OFDM symbols. Therefore, compared with the original frame structure, the total length of the frame remains unchanged, still 640 Ts, which is about 20.833 us.

TABLE 1
Frame structure using regular cyclic prefix
when multiple (sub)systems
coexist

| | | NCP | NCP | |
|---|---|---|---|---|
| | Length | length of | length of | |
| | of effective | other | the first | GP |
| | symbol | symbols | symbol | length |
| Length of each | 64 | 7 | 8 | 0 |
| symbol (Ts) | | | | |
| Number of | 9 | 8 | 1 | 0 |
| symbols | | | | |
| Subtotal (Ts) | 576 | 56 | 8 | 0 |

| | |
|---|---|
| Total (Ts) | 640 |

TABLE 2
Frame structure using extended cyclic
prefix when multiple (sub)systems
coexist

| | Length of | NCP | |
|---|---|---|---|
| | effective | length of the | GP |
| | symbol | first symbol | length |
| Length of each | 64 | 8 | 0 |
| symbol (Ts) | | | |
| Number of | 8 | 8 | 0 |
| symbols | | | |
| Subtotal (Ts) | 576 | 128 | 0 |

| | |
|---|---|
| Total (Ts) | 640 |

Compared with the traditional frame structure based on dedicated GP symbols, the new frame structure greatly improves the resource utilization when multiple (sub) systems coexist. In the case of using a regular cyclic prefix, the length of the cyclic prefix increases in the new frame structure (in the case of NCP: when multiple systems coexist, the NCP of the first symbol in the 9-symbol frame structure is 8 Ts, and the NCP of other symbols is 7 Ts. The NCP of the original 8-symbol frame structure is 5 Ts) and extends the coverage. In addition, compared with the 8 effective symbols in the original frame structure, the new frame structure of 9 effective symbols increases the utilization rate of system resources by 12.5%. In the case of using the extended cyclic prefix, the length of the cyclic prefix is increased in the new frame structure (in the case of ECP: when multiple systems coexist, the ECP length in the 8-symbol frame structure is 16 Ts. The ECP of the original 7-symbol frame structure is 14 Ts) and extends the coverage. In addition, compared with the 7 effective symbols in the original frame structure, the new frame structure of 8 effective symbols increases the utilization rate of system resources by 14.3%.

Taking a wireless short-range communication system as an example, the number of symbols used in the C link (or downlink) and T link (or uplink) in a radio frame supports the following two sets of configurations.

In the case of the regular cyclic prefix, the C/T symbol ratio in TABLE 3 may be used in the frame structure with and without the dedicated GP.

When the signaling indicates an 8-symbol NCP frame structure (as shown in TABLE 3), the terminal node may set the position of the C/T symbol conversion and the position after the last T symbol as the dedicated GP position and use the NCP frame structure according to the dedicated GP length of the frame structure configuration.

When the signaling indicates a 9-symbol NCP frame structure, the terminal node may interpret the C/T configuration ratio signaling differently according to whether the terminal node is currently working in the first (sub)system (or advanced domain) or the second (sub)system (or common domain).
When the terminal node works in the advanced domain, the first 8 symbol positions in the 9-symbol frame correspond to the 8 symbol positions in TABLE 3 one-to-one. The last symbol is regarded as an invalid symbol by default in the domain, but the last symbol may be used as a GP.
When the terminal node works in the common domain, the last 8 symbol positions in the 9-symbol frame correspond to the 8 symbol positions in TABLE 3 one-to-one. The first symbol is regarded as an invalid symbol in this domain by default, but the first symbol can be used as a GP.

TABLE 3
The ratio of C symbols and T symbols in a radio frame based
on the regular cyclic prefix configuration

| | Symbol configuration | | | | | | | |
|---|---|---|---|---|---|---|---|---|
| Radio frame structure | 0 | 1 | 2 | 3 | 4 | 5 | 6 | 7 |
| 0 | C | T | T | T | T | T | T | T |
| 1 | C | C | T | T | T | T | T | T |
| 2 | C | C | C | T | T | T | T | T |
| 3 | C | C | C | C | T | T | T | T |
| 4 | C | C | C | C | C | T | T | T |
| 5 | C | C | C | C | C | C | T | T |
| 6 | C | C | C | C | C | C | C | T |
| 7 | T | C | C | C | C | C | C | C |
| 8 | T | T | C | C | C | C | C | C |
| 9 | T | T | T | C | C | C | C | C |
| 10 | T | T | T | T | C | C | C | C |
| 11 | T | T | T | T | T | C | C | C |
| 12 | T | T | T | T | T | T | C | C |
| 13 | T | T | T | T | T | T | T | C |

When the signaling indicates a 7-symbol ECP frame structure (as shown in TABLE 4), similar to the processing method of the 8-symbol NCP frame structure, the terminal node may set the position of the C/T symbol conversion and the position after the last T symbol as the dedicated GP position and use the ECP frame structure according to the dedicated GP length of the frame structure configuration.

When the signaling indicates the 8-symbol ECP frame structure, similar to the processing method of the 9-symbol NCP frame structure, the terminal node may interpret the C/T configuration ratio signaling differently according to whether the terminal node is currently working in the first (sub)system (or advanced domain) or the second (sub)system (or common domain):
When the terminal node works in the advanced domain, the first 7 symbol positions in the 8-symbol frame correspond to the 7 symbol positions in TABLE 4 one-to-one. The last symbol is regarded as an invalid symbol by default in the domain, but the last symbol may be used as a GP.
When the terminal node works in the common domain, the last 7 symbol positions in the 8-symbol frame correspond to the 7 symbol positions in TABLE 4 one-to-one. The first symbol is regarded as an invalid symbol in this domain by default, but the first symbol can be used as a GP.

TABLE 4
The ratio of C symbols and T symbols in a radio frame based on the
extended cyclic prefix configuration

| | Symbol configuration | | | | | | |
|---|---|---|---|---|---|---|---|
| Radio frame structure | 0 | 1 | 2 | 3 | 4 | 5 | 6 |
| 0 | C | T | T | T | T | T | T |
| 1 | C | C | T | T | T | T | T |
| 2 | C | C | C | T | T | T | T |
| 3 | C | C | C | C | T | T | T |
| 4 | C | C | C | C | C | T | T |
| 5 | C | C | C | C | C | C | T |
| 6 | T | C | C | C | C | C | C |
| 7 | T | T | C | C | C | C | C |
| 8 | T | T | T | C | C | C | C |
| 9 | T | T | T | T | C | C | C |
| 10 | T | T | T | T | T | C | C |
| 11 | T | T | T | T | T | T | C |

The signaling may specify whether the (sub)system is an advanced domain or a common domain and which symbol length and the frame structure of the CP length.

For each domain, the signaling of the respective domain may indicate which symbols (except the symbols that are not available by default) are not available in the domain. In this way, combining the C/T symbol ratio and the available symbol configuration may form the actual symbol usage and configuration ratio settings of the respective domains. In addition, when the new frame structure is used to achieve coexistence, appropriate symbol positions need to be configured and reserved in the advanced domain since there is no dedicated GP position, so that the symbol positions of other domains (or invalid symbol positions in this domain) may be used for C/T conversion in advanced domains and ordinary domains.

For example, as shown in FIG. 7, the first (sub)system 710 (or advanced domain) indicates in the broadcast signaling a frame structure composed of 9 symbols and a second interval (GT2), indicates the C/T configuration ratio (5C:3T) defined by 8 symbols (corresponding to the first 8 symbols of the 9 symbols), and indicates the information indication of reserved symbols (unavailable symbols) (for example, the 8-bit bitmap corresponds to the symbols in the C/T position configuration ratio) to indicate that the symbols #3, #5, and #7 are not available. In another example, the available symbols may be indicated in the broadcast signaling. In the example in FIG. 7, the symbols #1, #2, #4, #6, and #8 are indicated as available. When the terminal node of this domain receives the C/T configuration ratio of 8 symbols, the terminal node may combine the first 8 symbol positions of the 9-symbol frame structure and the indication information of reserved symbols (unavailable symbols) to obtain the actual available symbol positions and C/T configuration ratio, namely 3C: 2T (the symbols #1, #2, and #4 of the 9 symbols are used for C transmission, and the symbols #6, #8 are used for T transmission). The C/T configuration ratio may be used as a basic configuration. If necessary, the intra-domain signaling may further indicate on this basis to update the configuration ratio to 2C:3T, wherein C of the symbol #4 may be reconfigured as a T transmission, and the reserved symbols #3 and #5 before and after the symbol #4 are used as GP. In addition, the symbol #9 is a first interval time (GT1). In this embodiment, the symbols #7 and #9 may also be used as GP.

For example, as shown in FIG. 7, the C node of the second (sub)system 720 (or common domain) can communicate with the C node of the first (sub)system (or advanced domain) through signaling to request for the number and position of symbols in a frame that the second (sub)system needs. The C node of the first (sub)system (or advanced domain) may be notified of the available frame structure, number of symbols, and positions of the C node of the second (sub)system (or common domain) through broadcast signaling or uni-cast signaling. As shown in FIG. 7, the symbols #3, #5 and #7 reserved by the first (sub)system 710 (or advanced domain) and the default reserved symbol #9 under the 9-symbol frame structure may be allocated for use in the second (sub)system 720 (or common domain). Therefore, the C node of the second (sub)system 720 (or common domain) may broadcast to indicate that a frame structure composed of 9 symbols and a second interval (GT2) is used in this domain, indicate the C/T configuration ratio (4C:4T) (corresponding to the last 8 symbol positions of 9 symbols), and indicates the information indication of reserved symbols (unavailable symbols) (for example, the 8-bit bitmap corresponds to the symbols in the C/T position configuration ratio) to indicate that the symbols #2, #4, #6, and #8 are not available. In another example, the signaling may indicate available symbols. In the example in FIG. 7, the symbols #3, #5, #7 and #9 are indicated as available. When the terminal node of this domain receives the C/T configuration ratio of 8 symbols, the terminal node may combine the last 8 symbol positions of the 9-symbol frame structure and the indication information of reserved symbols (unavailable symbols) of the last 8 symbols to obtain the actual available symbol positions and C/T configuration ratio, namely 2C: 2T (the symbols #3 and #5 of the 9 symbols are used for C transmission, and the symbols #7 and #9 are used for T transmission). The C/T configuration ratio may be used as a basic configuration. If necessary, the intra-domain signaling may further indicate on this basis to update the configuration ratio to 1C:3T, wherein C of the symbol #5 may be reconfigured as a T node, and the reserved symbols #4 and #6 before and after the symbol #5 are used as GP. In addition, the symbol #1 is a first interval time (GT1). In this embodiment, the symbols #1, #2 and #8 may also be used as GP.

Furthermore, when a second (sub)system (or common domain) is shared by a plurality of (sub)systems (or common domains), the C node of the first (sub)system (or advanced domain) may indicate which frame resources are allocated to each common domain. For example, the C node of the first (sub)system (or advanced domain) may indicate each frame corresponding to the frame-level bitmap. When the bitmap is set to 1, the frame resource is available; otherwise, the frame resource is not available. Then, the frame resources are repeatedly allocated and used according to the length of the bitmap, and a different bitmap may be received in each common domain.

In addition, which frames are used by each common domain may be derived by the modulo operation. The C node of the first (sub)system (or advanced domain) may give a number of resources N, and the frame resources of each domain may be determined by the number M (informed by the C node of the advanced domain through signaling) assigned to a common domain, the frame number X and the number of resources N. For example, for the frame X, the frames with Mod(X, N)=M are all allocated to the domain M for use.

In addition, a 1-bit reversal indicator may be added to the signaling to indicate a reversal configuration for the C/T configuration ratio, that is, the given C/T configuration in the original configuration becomes the T/C configuration. For example, when the reversal indicator is set to 1, the 5C:3T configuration ratio given in the signaling may be interpreted as 5T:3C. When the reversal indicator is set to 0, the configuration ratio remains unchanged.

Please note that in different embodiments, the above solutions may be implemented separately, or any two or more of them may be implemented in combination.

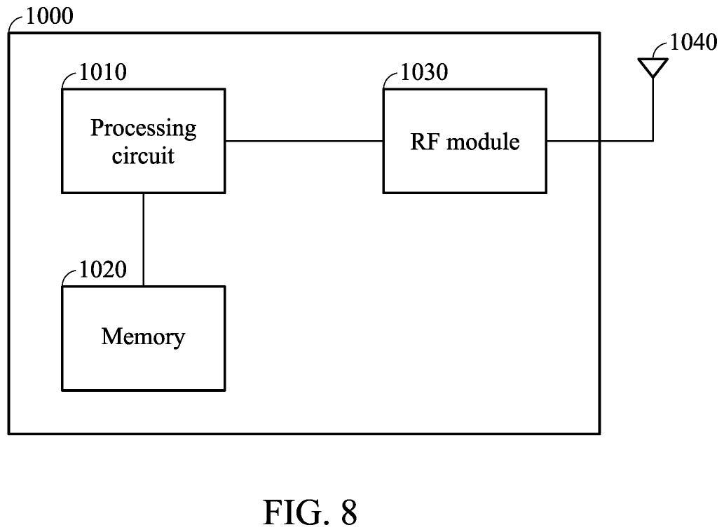

FIG. 8 illustrates an exemplary terminal node 1000 according to an embodiment of the present disclosure. The terminal node 1000 may be used in various embodiments of the present disclosure. In different examples, the terminal node 1000 may be a mobile phone, a tablet computer, a desktop computer, an in-vehicle device, and so on. As described in the above example, the terminal node 1000 may communicate with a wireless communication network, wherein the wireless communication network may be, for example, a 4th Generation (4G) LTE network, a 5G NR network or a combination thereof, and an in-vehicle wireless communication system. The terminal node 1000 may comprise a processing circuit 1010, a memory 1020, and a radio frequency (RF) module 1030.

In an example, the processing circuit 1010 may be used to execute the functions of the terminal node 1000 in various embodiments by executing program instructions stored in the memory 1020. For example, the processing circuit 1010 may perform the functions and processes described in the present disclosure. The memory 1020 may store program instructions, wherein the program instructions may cause the processing circuit to perform the functions of the terminal node 1000. The memory 1020 may include transitory or non-transitory storage media, such as read only memory (ROM), random access memory (RAM), flash memory and hard disk drives, etc.

The processing circuit 1010 may also be used to execute the functions or processes of the PHY layer in the various embodiments described in the present disclosure with or without executing the program instructions stored in the memory 1020. As described in the present disclosure, the functions or processes of the PHY layer may include synchronization, L1/L2 control channel or data channel decoding, etc. In addition, the functions of the PHY layer can also include coding and modulation.

The RF module 1030 receives the processed data signal from the processing circuit 1010 and transmits the data signal to the management node in the wireless communication network via the antenna 1040, and vice versa. The RF module 1030 may include various circuits, such as a digital-to-analog converter (DAC), an analog-to-digital converter (ADC), a frequency up converter, and a frequency down converter, filter and amplifier, etc. for receiving and transmitting operations.

The terminal node 1000 may optionally include other elements, such as input and output devices, other additional signal processing circuits, and the like. Therefore, the terminal node 1000 may perform other additional functions, such as executing application programs and processing alternative communication protocols.

The processes and functions described in the present disclosure may be implemented as computer programs. When the computer programs are executed by one or more processors, one or more processors may execute various processes and functions. The computer program may be stored or distributed on a suitable medium, such as an optical storage medium or a solid-state medium provided with or as a part of other hardware. The computer programs can also be distributed in other forms, such as via the Internet or other wired or wireless remote communication systems. For example, the computer programs can be obtained through physical media or distributed systems (such as servers connected to the Internet) and loaded into the device.

The computer program can be accessed from a computer-readable medium, wherein the computer-readable medium is used to provide program instructions used by or connected to a computer or any instruction execution system. The computer-readable medium may include any apparatus that can contain, store, communicate, propagate, or transport computer program for use by or in connection with the instruction execution system, apparatus, or device. The computer-readable medium may be a magnetic, optical, electronic, electromagnetic, infrared, or semiconductor system (or apparatus or device) or a propagation medium. The computer-readable media may include computer-readable non-transitory storage media, such as semiconductor or solid-state memory, magnetic tape, removable computer disks, random access memory (RAM), a read-only memory (ROM), a rigid magnetic disk and an optical disk. The computer-readable non-transitory storage media may include all kinds of computer-readable media, including magnetic storage media, optical storage media, flash memory media, and solid-state storage media.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for shared frame configuration of multiple (sub)systems, wherein the method is used in a first device of a first (sub)system and comprises:
determining whether the first (sub)system is a highest-priority system; and
determining the allocation of resources of time symbols in a shared frame in the multiple (sub) system when the first (sub)system is a highest-priority system.

2. The method for shared frame configuration of multiple (sub)systems as claimed in claim 1, further comprising:
broadcasting configuration information, wherein the configuration information indicates the time symbols used for the first (sub)system in the shared frame.

3. The method for shared frame configuration of multiple (sub)systems as claimed in claim 1, further comprising:
receiving a signaling request from a second (sub)system, wherein the signaling request is used to request the first (sub)system to reserve at least one time symbol in the shared frame for the second (sub)system to transmit information; and
reconfiguring the time symbols used in the first (sub)system in the shared frame according to the signaling request.

4. The method for shared frame configuration of multiple (sub)systems as claimed in claim 1, wherein when a plurality of systems time-division multiplex the shared frame, the first (sub)system configures the resources of a discrete time symbol and avoids the allocation of dedicated GP resources; and
wherein when no system uses the shared frame except for the first (sub)system, the first (sub)system configures the shared frame to have the dedicated GP resources.

5. The method for shared frame configuration of multiple (sub)systems as claimed in claim 1, wherein the first device determines whether the first (sub)system is a highest-priority system based on a synchronization sequence number of the first (sub)system.

6. The method for shared frame configuration of multiple (sub)systems as claimed in claim 1, wherein the shared frame is composed of the time symbols, a first interval time (GT1) and a second interval time (GT2) in sequence.

7. The method for shared frame configuration of multiple (sub)systems as claimed in claim 6, wherein the first interval time is an invalid symbol for configuring dedicated GP resources.

8. The method for shared frame configuration of multiple (sub)systems as claimed in claim 1, wherein when the first (sub)system is a second highest-priority system, the shared frame is composed of a first interval time (GT1), the time symbols, and a second interval time (GT2) in sequence.

9. The method for shared frame configuration of multiple (sub)systems as claimed in claim 3, wherein the information is control information, feedback information, synchronization signals or broadcast information.

10. The method for shared frame configuration of multiple (sub)systems as claimed in claim 2, wherein the at least one time symbol is a time symbol before or after a switching point of the shared frame.

11. A device for shared frame configuration of multiple (sub)systems, comprising:
one or more processors; and
one or more computer storage media for storing one or more computer-readable instructions, wherein the processor is configured to drive the computer storage media to execute the following tasks:
determining whether the first (sub)system is a highest-priority system; and
determining the allocation of resources of time symbols in a shared frame in the multiple (sub) system when the first (sub)system is a highest-priority system.

12. The device for shared frame configuration of multiple (sub)systems as claimed in claim 11, wherein the processor further executes the following tasks:
broadcasting configuration information, wherein the configuration information indicates the time symbols used for the first (sub) system in the shared frame.

13. The device for shared frame configuration of multiple (sub)systems as claimed in claim 11, wherein the processor further executes the following tasks:
receiving a signaling request from a second (sub)system, wherein the signaling request is used to request the first (sub)system to reserve at least one time symbol in the shared frame for the second (sub)system to transmit information; and
reconfiguring the time symbols used in the first (sub)system in the shared frame according to the signaling request.

14. The device for shared frame configuration of multiple (sub)systems as claimed in claim 11, wherein when a plurality of systems time-division multiplex the shared frame, the first (sub)system configures the resources of a discrete time symbol and avoids the allocation of dedicated GP resources; and
wherein when no system uses the shared frame except for the first (sub)system, the first (sub)system configures the shared frame to have the dedicated GP resources.

15. The device for shared frame configuration of multiple (sub)systems as claimed in claim 11, wherein the first device determines whether the first (sub)system is a highest-priority system based on a synchronization sequence number of the first (sub)system.

16. The device for shared frame configuration of multiple (sub)systems as claimed in claim 11, wherein the shared frame is composed of the time symbols, a first interval time (GT1) and a second interval time (GT2) in sequence.

17. The device for shared frame configuration of multiple (sub)systems as claimed in claim 16, wherein the first interval time is an invalid symbol for configuring dedicated GP resources.

18. The device for shared frame configuration of multiple (sub)systems as claimed in claim 11, wherein when the first (sub)system is a second highest-priority system, the shared frame is composed of a first interval time (GT1), the time symbols, and a second interval time (GT2) in sequence.

19. The device for shared frame configuration of multiple (sub)systems as claimed in claim 13, wherein the information is control information, feedback information, synchronization signals or broadcast information.

20. The device for shared frame configuration of multiple (sub)systems as claimed in claim 12, wherein the at least one time symbol is a time symbol before or after a switching point of the shared frame.
